(19) United States
(12) Patent Application Publication
(10) Pub. No.: US 2019/0064569 A1
(43) Pub. Date: Feb. 28, 2019

(54) ANTISTATIC FILM AND DISPLAY INPUT DEVICE

(71) Applicant: Kabushiki Kaisha Kobe Seiko Sho (Kobe Steel, Ltd.), Kobe-shi (JP)

(72) Inventors: Toshihiro KUGIMIYA, Kobe-shi (JP); Mototaka OCHI, Kobe-shi (JP); Ayuko KAWAKAMI, Kobe-shi (JP)

(73) Assignee: Kabushiki Kaisha Kobe Seiko Sho (Kobe Steel, Ltd.), Kobe-shi (JP)

(21) Appl. No.: 16/081,104

(22) PCT Filed: Feb. 28, 2017
(86) PCT No.: PCT/JP2017/007907

§ 371 Date: Aug. 30, 2018

(30) Foreign Application Priority Data
Mar. 28, 2016 (JP) 2016-064482

(51) Int. Cl. G02F 1/1333; G06F 3/041; G06F 3/044

(52) U.S. Cl. CPC G02F 1/13338; G06F 3/0412; G02F 2203/01; G02F 2202/22; G06F 3/044

(57) ABSTRACT

Disclosed is an antistatic film having a light-transmissive property provided on a light-transmissive member, comprising In, Zn, Sn and O.

### TECHNICAL FIELD

The present disclosure relates to an antistatic film having a light-transmissive property and a display input device using the same.

### BACKGROUND ART

Displays having touch panels mounted thereon as input devices are widely used in smartphones, tablets, notebook PCs and the like. Such displays with the touch panels mounted thereon are either of a resistive film type or an electrostatic capacitance type, for example. The type of display is appropriately selected depending on applications of the display and the like.

Patent Document 1 proposes a display that utilizes an in-cell touch sensor component, containing an in-cell black matrix material, or an on-cell touch sensor component, containing an on-cell black matrix material, the touch sensor component acting as a touch drive electrode or a touch-sensing electrode (Patent Document 1).

Patent Document 2 proposes a simplified structure of a liquid crystal display equipped with an electrostatic capacitance type touch sensor of in-cell type (Patent Document 2).

### PRIOR ART DOCUMENT

### Patent Document

Patent Document 1: JP 2014-532192 A
Patent Document 2: JP 2014-41603 A

### SUMMARY OF THE INVENTION

### Problems to be Solved by the Invention

The electrostatic capacitance touch panel needs to include an antistatic film, in other words, a transparent (light-transmissive) conductive film that is capable of transmitting a sufficient amount of light in the display, while exerting an antistatic function of preventing the malfunction of the display due to low-frequency noise in the vicinity of the display. If the sheet resistance of the antistatic film is extremely low, there arises a problem that a high-frequency signal corresponding to the sensitivity (capacity) of the touch panel is cut off. This problem is more likely to occur in the in-cell type touch panel. Due to this, the antistatic film is required to have a sheet resistance of approximately 1×10⁷ Ω/□ or more. However, the displays disclosed in Patent Documents 1 and 2 do not address the problem mentioned above.

A commonly used transparent (light-transmissive) conductive film is an In—Sn—O (ITO) thin film. However, the sheet resistance of this film in a practicable film thickness is approximately 10⁴ Ω/□, and thus it is difficult to achieve the transparent conductive film having a high resistance.

In view of the foregoing problems, it is an object of embodiments of the present invention to provide an antistatic film which has high sheet resistance and high transmittance (transmittancy). Furthermore, it is another object of the embodiments of the present invention to provide a display input device which includes such an antistatic film.

### Means for Solving the Problems

An antistatic film according to the embodiments of the present invention has a light-transmissive property, and is provided on a light-transmissive member, wherein the antistatic film contains In, Zn, Sn and O.

The antistatic film according to the embodiments of the present invention may further contain at least one selected from the group consisting of V, Mn, Co and Mo.

The antistatic film according to the embodiments of the present invention may be provided on one surface of a transparent substrate which is the light-transmissive member having a color filter on another surface thereof.

In the antistatic film according to the embodiments of the present invention, a sheet resistance of the antistatic film may be 1×10⁷ to 1×10¹³Ω/□, and a light transmittance of the antistatic film at a wavelength of 450 nm may be 82% or more at a film thickness of 10 nm.

A display input device according to the embodiments of the present invention includes the antistatic film according to the embodiments of the present invention.

### Effects of the Invention

The antistatic film according to the embodiments of the present invention has the high sheet resistance and the high transmittance.

### BRIEF DESCRIPTION OF THE DRAWINGS

FIG. 1 is an exploded perspective view schematically showing a configuration of a display input device according to an embodiment of the present invention.

FIG. 2 is an exploded perspective view schematically showing a configuration of a display input device according to an embodiment of the present invention.

FIG. 3 is a graph showing the relationship between the sheet resistances of the antistatic films according to embodiments of the present invention and the partial pressures of oxygen in a carrier gas at the time of forming the antistatic film.

FIG. 4 is a graph showing the relationship between the sheet resistances of the antistatic film and the film thicknesses of the antistatic film according to an embodiment of the present invention.

FIG. 5 is a graph showing the relationship between the sheet resistances of the antistatic film according to embodiments of the present invention and the partial pressures of oxygen in the carrier gas at the time of forming the antistatic film.

FIG. 6 is a graph showing the relationship between the light transmittances at 450 nm through the antistatic films according to embodiments of the present invention and the partial pressures of oxygen in the carrier gas at the time of forming the antistatic film.

### MODE FOR CARRYING OUT THE INVENTION

The antistatic film according to the embodiments of the present invention has a light-transmissive property, and is provided on a light-transmissive member, wherein the antistatic film contains In, Zn, Sn and O. The antistatic film according to the embodiments of the present invention will be described in detail below.

### <1. Antistatic Film>

### [Composition of Antistatic Film]

The antistatic film according to the embodiments of the present invention contains In, Zn, Sn and O. The antistatic film according to the embodiments of the present invention may further contain at least one selected from the group consisting of V, Mn, Co and Mo.

Each metal element will be described in detail below.

The term content of a metal element as used herein means the proportion of the metal element in 100 atomic % [at %] of the total of metal elements constituting the antistatic film.

### (1) In

In is an element effective for controlling a carrier density of a thin film. When an antistatic film is formed at room temperature, if a carrier density of the thin film is low, a resistance of this film tends to increase. In particular, if a partial pressure of oxygon at the time of sputtering is low, the tendency becomes remarkable. The lower a carrier density of a thin film is, the higher a light transmittance of the thin film becomes, and in particular, a light transmittance of the thin film in an infrared region becomes higher. Thus, by adjusting the In content, a carrier density of a thin film can be controlled to achieve both excellent transmittance and sheet resistance.

From the viewpoint of appropriately controlling a carrier density of a thin film, the In content can be set at, for example, 21.2 atomic %.

### (2) Zn

Zn is an element that affects a wet etching rate. If the Zn content is extremely small, a wet etching rate sometimes becomes low when a wet etching solution for processing an oxide semiconductor is used. From the viewpoint of achieving a good wet etching rate, the lower limit of In content is preferably 5 atomic %, and more preferably 15 atomic %.

In contrast, if the Zn content is extremely large, a wet etching rate becomes extremely high in a wet etching solution for processing an oxide semiconductor, and thus it may be difficult to achieve a desired pattern shape. Thus, the upper limit of Zn content is preferably 55 atomic %, and more preferably 45 atomic %.

### (3) Sn

Sn is an element effective for improving a wet etching resistance. If the Sn content is extremely small, a wet etching rate increases. Due to this, when an antistatic film is wet-etched, the film thickness of the antioxidant film decreases, alternatively, damage to the surface of the antioxidant film becomes significant, and thus properties of the antistatic film, such as a sheet resistance, may be degraded. In addition, a wet etching property in a wet etching solution for processing an oxide semiconductor may be deteriorated. Therefore, the lower limit of Sn content is preferably 8 atomic %, and more preferably 15 atomic %.

In contrast, if the Sn content is extremely large, a wet etching rate in a wet etching solution for processing an oxide semiconductor may be reduced (that is, a wet etching property may be degraded). In particular, such an antistatic film may become insoluble in an organic acid, such as oxalic acid, commonly used as a wet etching solution for processing an oxide semiconductor, and consequently the antistatic film cannot be processed in some cases.

When an antistatic film is formed at room temperature, if the Sn content is extremely large, a carrier density of the thin film becomes low, so that a resistance of the thin film tends to increase. In particular, when a partial pressure of oxygen is low at the time of sputtering, the tendency becomes remarkable. The lower a carrier density of a thin film is, the higher a transmittance of the thin film becomes, and in particular, a transmittance of the thin film in an infrared region becomes higher.

Thus, the upper limit of Sn content is preferably 40 atomic %, and more preferably 30 atomic %.

### (4) V, Mn, Co and Mn

A partial pressure of oxygen in a carrier gas is adjusted by introducing oxygen into the carrier gas when an antistatic film is manufactured, as will be mentioned later. A sheet resistance of a formed antistatic film is known to depend on a partial pressure of oxygen at the time of sputtering.

To achieve the high sheet resistance, it is effective to increase a partial pressure of oxygen. However, when a partial pressure of oxygen is high, the sheet resistance becomes higher than a desired value, and thus it may be difficult to control the sheet resistance. In contrast, when a partial pressure of oxygen is low, the sheet resistance of the antistatic film tends to vary, and thus it may be difficult to adjust a partial pressure of oxygen in accordance with the variation in the sheet resistance.

V, Mn, Co and Mn have the effect of reducing a partial pressure of oxygen which is necessary in order to achieve the high sheet resistance. Thus, these elements make it less likely to vary the sheet resistance and facilitate the adjustment of a partial pressure of oxygen. Therefore, by containing at least one of V, Mn, Co and Mn, the antistatic film having the high sheet resistance can be more stably manufactured.

From the viewpoint of reducing a partial pressure of oxygen and facilitating the adjustment of a partial pressure of oxygen, the lower limit of V content is preferably 0.2 atomic %, and more preferably 0.5 atomic %. The upper limit of V content is preferably 5.0 atomic %, and more preferably 3.0 atomic %.

From the same viewpoint, the lower limit of Mn content is preferably 0.5 atomic % and more preferably 0.8 atomic %, whereas the upper limit of Mn content is preferably 6.0 atomic % and more preferably 4.0 atomic %.

From the same viewpoint, the lower limit of Co content is preferably 0.7 atomic % and more preferably 1.0 atomic %, whereas the upper limit of Co content is preferably 15 atomic % and more preferably 12 atomic %.

From the same viewpoint, the lower limit of Mo content is preferably 1.0 atomic % and more preferably 2.0 atomic %, whereas the upper limit of Mo content is preferably 10.0 atomic % and more preferably 8.0 atomic %.

From the viewpoint of achieving the high transmittance while facilitating the adjustment of a partial pressure of oxygen, V, Mn and Co are more preferable.

The antistatic film according to the embodiments of the present invention may contain inevitable impurities. The inevitable impurities could be brought in the antistatic film, depending on the conditions of raw materials, constituent materials, manufacturing facilities and the like. Examples of inevitable impurities include Fe, Ni, Ti, Mg, Cr, Zr and the like. The upper limit of the content of the inevitable impurities is preferably 0.05% by weight.

From the viewpoint of improving a durability (resistance to environment) under high temperature and high humidity conditions, it is preferable to adjust a density of the antistatic film. Thus, the lower limit of a density of the antistatic film is preferably 5.5 g/cm³, and more preferably 6.0 g/cm³.

The sheet resistance as used herein is a value measured using a resistivity meter.

From the viewpoint of achieving both better antistatic properties and sensitivity of a touch panel, the lower limit of the sheet resistance of the antistatic film according to the embodiments of the present invention is preferably 1×10⁷ Ω/□, and more preferably 1×10⁸ Ω/□, whereas the upper limit thereof is preferably 1×10¹³Ω/□, and more preferably 1×10¹²Ω/□.

The film thickness of the antistatic film may be measured by a step profiler or a cross-sectional observation.

From the viewpoint of achieving both better transmittance and sheet resistance, the lower limit of the film thickness of the antistatic film according to the embodiments of the present invention is preferably 10 nm and more preferably 15 nm, whereas the upper limit thereof is preferably 50 nm and more preferably 40 nm.

The transmittance (transmittancy) of the antistatic film is a value obtained by measuring the spectral reflectance of the antistatic film using an ultraviolet spectrophotometer, and is the ratio of the intensity of transmitted light through the antistatic film to the intensity of transmitted light through a reference mirror.

In the antistatic film, the lower limit of the light transmittance at a wavelength of 450 nm is preferably 82%, more preferably 90%, and further preferably 95%, at the film thickness of 10 nm. By measuring the light transmittance at 450 nm, the transmittance properties of the display can be evaluated.

The antistatic film according to the embodiments of the present invention has the high sheet resistance and the high transmittance, and hence can be suitable for use in displays. Thus, the antistatic film also has an excellent electromagnetic shielding property, while exhibiting an excellent antistatic property. The antistatic film according to the embodiments of the present invention can be efficiently manufactured because it leaves little residue when being etched in a manufacturing process.

### [Method of Manufacturing Antistatic Film]

The antistatic film according to the embodiments of the present invention can be manufactured by a known sputtering method, for example, a magnetron sputtering method using a sputtering target.

In the antistatic film according to the embodiments of the present invention, the composition of metal elements constituting the antistatic film may be different from that of the sputtering target used for forming the antistatic film. For example, since the vapor pressure of Zn is higher than that of other metal elements, Zn is more likely to evaporate compared to other metal elements under a vacuum condition for the film formation. Furthermore, the proportion of Zn in the antistatic film may be smaller than the proportion of Zn in the sputtering target used for the film forming. Therefore, in order to obtain the antistatic film having a desired composition, the composition of the sputtering target may be adjusted as appropriate.

When the antistatic film is formed by a sputtering method, this antistatic thin film is desirably formed continuously while a vacuum state is maintained. This is because, if the deposited film is exposed to the atmosphere when the antistatic film is formed, moisture or an organic component in the air adheres to the surface of the thin film, which causes contamination (defective quality).

In the case of forming the film by a sputtering method, a gas pressure, an amount of added oxygen (partial pressure of oxygen) in the gas, an input power to a sputtering target, a substrate temperature, a T-S distance (the distance between the sputtering target and the substrate), and the like are preferably controlled appropriately during the film formation. Specifically, for example, the film formation is preferably performed under the following sputtering conditions.

When the film formation is performed by a sputtering method, preferably, the substrate temperature is controlled to a temperature between the room temperature and approximately 200° C., and the amount of added oxygen is appropriately controlled.

The amount of added oxygen (partial pressure of oxygen) may be appropriately controlled depending on the configuration of a sputtering device, the composition of the sputtering target, and the like so as to obtain the preferable sheet resistance and/or transmittance for the antistatic film, for example, the sheet resistance of 5.0×10⁶ to 1×10¹⁴Ω/□, and/or the transmittance of 80% or more.

The density of the antistatic film is preferably adjusted from the viewpoint of improving a durability (resistance to the environment) under high-temperature and high-humidity conditions as mentioned above by appropriately controlling the gas pressure, the input power to the sputtering target, the TS distance (distance between the sputtering target and the substrate), and the like when the film formation is performed using the sputtering.

To obtain the above-mentioned density, for example, a gas pressure during the film formation is preferably set within a range of approximately 1 to 3 mTorr. The higher input power is preferable, and the input power is preferably set at approximately 200 W or more.

The density of the antistatic film is also affected by heat treatment conditions after the film formation. Because of this, the heat treatment conditions after the film formation are also preferably controlled appropriately. The heat treatment after the film formation is, for example, a preannealing treatment (heat treatment performed after patterning by wet-etching an antistatic film layer), which may be performed at 120° C. for approximately 5 minutes under the atmosphere or under a steam atmosphere.

### <2. Display Input Device>

The antistatic film according to the embodiments of the present invention has the light-transmissive property, and is provided on a light-transmissive member and has the light-transmissive proporty. The antistatic film may be used in an arbitrary display and can be used in a display input device including a touch sensor. The light-transmissive member is, for example, a transparent substrate and the like, as will be mentioned later.

The display input device according to the embodiments of the present invention includes the antistatic film according to the embodiments of the present invention, and further includes a touch sensor to be mentioned later, and thus the display input device can be operated with the user's finger tips or the like. By including the antistatic film with excellent antistatic property and light transmittance, the display input device has excellent transmittance of light from the display with fewer malfunctions.

Since the figures referred to in the following description schematically show the embodiments of the present invention, scale, spacing, positional relationship, and the like of respective members may be exaggerated, or parts of the members may not be illustrated. In the following description, the same names and reference numerals denote the same or similar members in principle, and a detailed description thereof is omitted as appropriate.

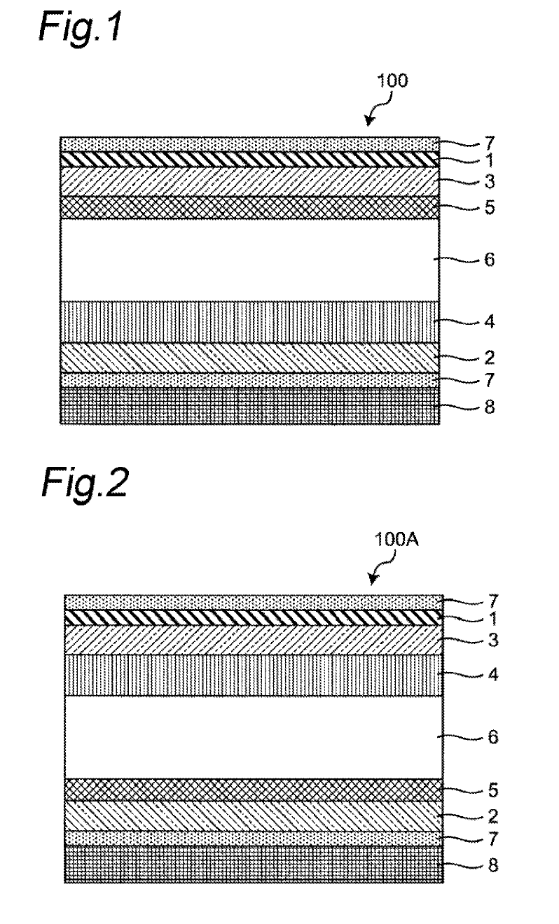

FIG. 1 is an exploded perspective view schematically showing a configuration of a display input device 100 according to an embodiment of the present invention. The display input device 100 is an in-cell type, and a touch sensor 4 is provided between a first transparent substrate 2 and a second transparent substrate 3.

The touch sensor 4 is provided on the first transparent substrate 2.

The antistatic film 1 is provided on a surface opposite to the surface of the second transparent substrate 3 on which a color filter 5 is provided.

FIG. 2 is an exploded perspective view schematically showing a configuration of a display input device 100A according to an embodiment of the present invention. The display input device 100A is an in-cell type, and the touch sensor 4 is provided between the first transparent substrate 2 and the second transparent substrate 3.

Unlike the display input device 100, the touch sensor 4 is provided on a liquid crystal layer 6.

Furthermore, unlike the display input device 100, the antistatic film 1 is provided on a surface opposite to the surface of the second transparent substrate 3 on which the touch sensor 4 is provided.

The respective components will be described below.

The first transparent substrate 2 is a glass substrate and is provided with a TFT.

Examples of materials constituting the TFT are, for example, an In—Zn—Sn—O-based oxide semiconductor thin film (IZTO), an In—Ga—Sn—O-based oxide semiconductor thin film (IGTO), an In—Ga—Zn—Sn—O-based oxide semiconductor thin film (IGZTO), an In—Ga—Zn—O-based oxide semiconductor thin film (IGZO), amorphous silicon, low-temperature polysilicon, and the like. The material constituting the TFT may be appropriately selected depending on the configuration or application of a display and the like.

The color filter 5 and the liquid crystal layer 6 is provided over the TFT of the first transparent substrate 2.

The color filter 5 may be configured to transmit red, green or blue light, for example. The type of the liquid crystal may be appropriately selected in accordance with a liquid crystal driving mode, such as a TN mode, a VA mode, an FFS mode, an IPS mode or the like. From the viewpoint of obtaining a wide viewing angle, the FFS mode or the IPS mode is more preferable.

The second transparent substrate 3 is a glass substrate, which is a transparent substrate provided on the color filter 5 and the liquid crystal layer 6 and opposed to the first transparent substrate 2. The color filter 5 and the liquid crystal layer 6 are disposed between these transparent substrates to form the main body of the display device 100.

The touch sensor 4 is the electrostatic capacitance type that includes a touch drive electrode, a dielectric layer and a touch sensing electrode. The touch sensor 4 detects a position of touch by capturing a change in the electrostatic capacitance between the touch sensor and a conductor, such as a fingertip.

Like the display input devices 100 and 100A of the present embodiments shown in FIGS. 1 and 2, the touch sensor 4 may be disposed between the first transparent substrate 2 and the second transparent substrate 3, and may constitute an in-cell type display input device. Alternatively, depending on the configuration of a display input device, the touch sensor 4 may be disposed outside between the first transparent substrate 2 and the second transparent substrate 3, and an on-cell type display input device may be constituted.

In addition to the above-mentioned components, the display input device 100 includes polarizing plates 7 and a backlight 8.

Depending on their configurations, the display input devices 100 and 100A may include transparent electrodes, alignment films, black matrixes, spacers, insulating films, adhesive layers, film layers and the like, all of which are located appropriately and may be arranged between the respective components as appropriate.

### EXAMPLES

### Example 1

### (1) Formation of Antistatic Film

A sputtering target having the composition of In:Zn:Sn=20.0 atomic %:56.6 atomic %:23.4 atomic % was attached to an electrode in a chamber of a DC magnetron sputtering system “CS200” manufactured by ULVAC, Inc., and then the pressure in the chamber was adjusted to 1 mTorr. Subsequently, a carrier gas (a mixed gas of Ar and O₂, partial pressure of oxygen: O₂/(O₂+Ar)=4%) was introduced into the chamber, and the pressure in the chamber was adjusted to 2 mTorr. Then, by applying a sputter power of DC300W to the sputtering target at room temperature, the antistatic film, denoted as No. 1 in Table 1, which had a thickness of 40 nm, was formed on a glass substrate (Eagle XG, manufactured by Corning Inc., having a diameter of 2 inches and a thickness of 0.7 mm).

The antistatic films Nos. 2 to 6 were formed in the same manner as mentioned above, except that the partial pressure of oxygen in the carrier gas was varied in a range from 8 to 20%, as shown in Table 1.

### (2) Composition Analysis

The composition of each metal element in the total content 100 atomic % of the metal elements was measured by an ICP luminescence analysis method. The composition of each of the antistatic films Nos. 1 to 6 was In:Zn:Sn=21.2 atomic %:54.7 atomic %:24.1 atomic %.

### (3) Thermal History Test

The sheet resistance of each of the antistatic films Nos. 1 to 6 obtained in the above-mentioned (1) was measured using a resistivity meter “Hiresta UP” (model number: MCP-HT450, measuring method: ring-electrode method) manufactured by Mitsubishi Chemical Analytech Co., Ltd.

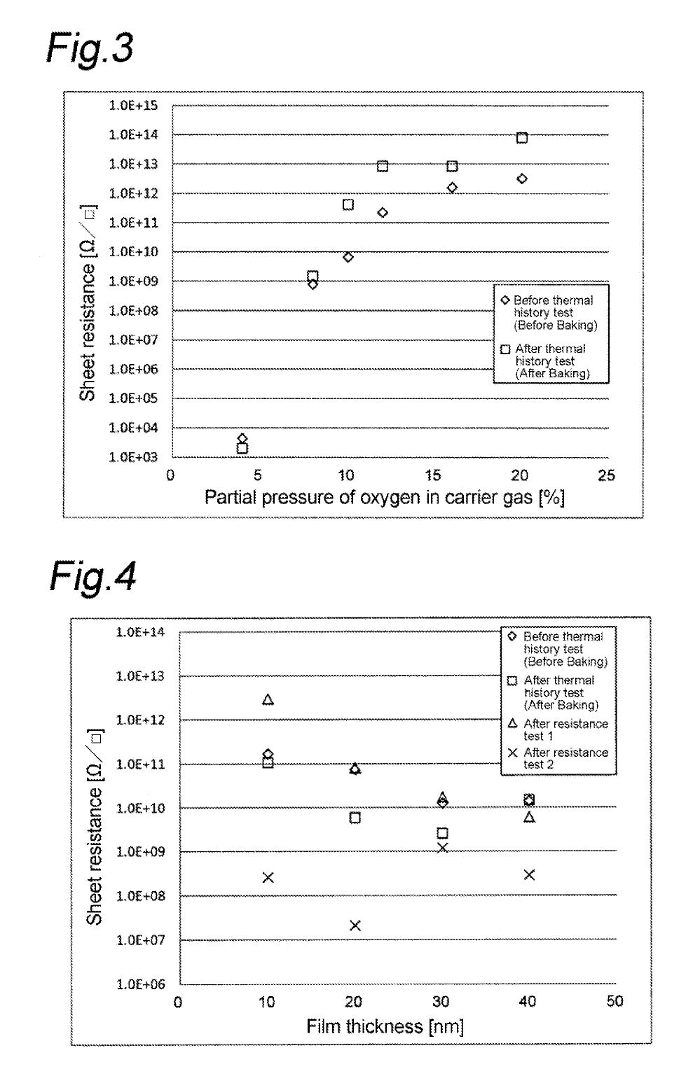

Thereafter, baking was performed on the antistatic films at 120° C. for 5 minutes to make each antistatic film experience a thermal history corresponding to the actual manufacturing process, and then the sheet resistance of each of the antistatic film was measured. Table 1 shows the measurement results of the sheet resistances. FIG. 3 is a graph showing the relationship between the sheet resistances and the partial pressures of oxygen.

TABLE 1

| | |
|---|---|
| Partial | Sheet resistance (Ω/□) |

| | pressure of | Before thermal | After thermal |
|---|---|---|---|
| Example 1 | oxygen in | history test | history test |
| No. | carrier gas (%) | (Before baking) | (After baking) |
| 1 | 4 | 4.4 × 10³ | 2.0 × 10³ |
| 2 | 8 | 8.0 × 10⁸ | 1.5 × 10⁹ |
| 3 | 10 | 6.6 × 10⁹ | 4.1 × 10¹¹ |
| 4 | 12 | 2.2 × 10¹¹ | 8.4 × 10¹² |
| 5 | 16 | 1.6 × 10¹² | 8.5 × 10¹² |
| 6 | 20 | 3.2 × 10¹² | 7.9 × 10¹³ |

As can be seen from Table 1 and FIG. 3, all antistatic films Nos. 1 to 6 contained In, Zn, Sn and O, and exhibited the excellent sheet resistance of 1×10⁷ to 1×10¹³Ω/□, at both before and after the thermal history test, regardless of the partial pressure of oxygen in the carrier gas during the formation of the antistatic film.

The antistatic films Nos. 2 to 4 had a sheet resistance of 8.0×10⁸ to 8.4×10¹²Ω/□, and thus can achieve both better antistatic properties and sensitivity of a touch panel.

### Example 2

### (1) Formation of Antistatic Film

Antistatic films Nos. 7 to 10 having the film thickness (10 to 40 nm) shown in Table 2 were formed in the same manner as in Example 1, except that the partial pressure of oxygen was set at 8%.

### (2) Composition Analysis

The composition of each metal element in the total content 100 atomic % of the metal elements was measured by an ICP luminescence analysis method. The composition of each of the antistatic films Nos. 7 to 9 was In:Zn:Sn=21.2 atomic %:54.7 atomic %:24.1 atomic %.

### (3) Thermal History Test

The sheet resistance of each of the antistatic films Nos. 7 to 10 obtained in the above-mentioned (1) was measured in the same manner as in Example 1.

Thereafter, baking was performed on the antistatic films at 120° C. for 5 minutes to make each antistatic film experience a thermal history corresponding to the actual manufacturing process, and then the sheet resistance of each of the antistatic film was measured. Table 2 shows the measurement results of the sheet resistances. FIG. 4 is a graph showing the relationship between the sheet resistances and the film thicknesses of each antistatic film.

### (4) Resistance Test for Resist Removal Step [Resistance Test 1]

The antistatic films Nos. 7 to 10 obtained in the above-mentioned (1) were subjected to a resistance test for a resist remover by simulating conditions for an actual resist removal step.

First, baking was performed on the antistatic films Nos. 7 to 10, which were obtained in the above-mentioned (1), at 120° C. for 5 minutes to make the antistatic films experience a thermal history corresponding to the actual manufacturing process.

Then, the antistatic films were immersed in the resist remover “TOK104” manufactured by TOKYO OHKA KOGYO CO., LTD., at 70° C. for 10 minutes. Subsequently, the antistatic films were washed with water for 5 minutes, and subjected to baking at 120° C. for 30 minutes. Thereafter, the antistatic films were cooled down to the room temperature, and then the sheet resistances of the antistatic films were measured. Table 2 shows the measurement results of the sheet resistances. FIG. 4 is a graph showing the relationship between the sheet resistances and the film thicknesses of each antistatic film.

### (5) Resistance Test for Etching Process [Resistance Test 2]

The antistatic films Nos. 7 to 10 obtained in the above-mentioned (1) were subjected to a resistance test for an etching solution and a resist remover in the following procedure by simulating conditions for the actual etching step.

First, baking was performed on the antistatic films Nos. 7 to 9 obtained in the above-mentioned (1) at 120° C. for 5 minutes to make the antistatic films experience a thermal history corresponding to the actual manufacturing process.

Thereafter, Al electrode was formed on the antistatic films, which were then immersed in the etching solution (phosphoric acid:70% by mass, nitric acid:1.9% by mass, acetic acid:10% by mass, and water: 18.1% by mass) at room temperature. The immersion time was 120% of the time during which the whole Al electrode was etched.

Then, the antistatic films were immersed in the resist remover “TOK104” manufactured by TOKYO OHKA KOGYO CO., LTD., at 80° C. for 10 minutes. Subsequently, the antistatic films were washed with water for 5 minutes, and subjected to baking at 120° C. for 30 minutes. Thereafter, the antistatic films were cooled down to the room temperature, and then the sheet resistances of the antistatic films were measured. Table 2 shows the measurement results of the sheet resistances. FIG. 4 shows a graph of the relationship between the sheet resistances and the film thicknesses of each antistatic film.

TABLE 2

| | | Sheet resistance (Ω/□) | | | |
|---|---|---|---|---|---|
| | Film | Before thermal | After thermal | | |
| | thickness of | history test | history test | After | After |
| | antistatic | (Before | (After | resistance | resistance |
| Example 2 No. | film (nm) | baking) | baking) | test 1 | test 2 |
| 7 | 40 | 1.4 × 10¹⁰ | 1.5 × 10¹⁰ | 6.1 × 10⁹ | 2.9 × 10⁸ |
| 8 | 30 | 1.3 × 10¹⁰ | 2.6 × 10⁹ | 1.7 × 10¹⁰ | 1.2 × 10⁹ |
| 9 | 20 | 7.3 × 10¹⁰ | 5.9 × 10⁹ | 8.1 × 10¹⁰ | 2.1 × 10⁷ |
| 10 | 10 | 1.7 × 10¹¹ | 1.1 × 10¹¹ | 3.0 × 10¹² | 2.6 × 10⁸ |

As can be seen from Table 2 and FIG. 4, all antistatic films Nos. 7 to 10 contained In, Zn, Sn and O, and exhibited the excellent sheet resistance of 1×10⁷ to 1×10¹³Ω/□, at any time before the thermal history test, after the thermal history test, after the resistance test 1 and after the resistance test 2, regardless of the film thickness of the antistatic film. Thus, these antistatic films can achieve both better antistatic properties and sensitivity of a touch panel.

### Example 3

### (1) Formation of Antistatic Film

An antistatic film No. 7 shown in Table 2 was formed in the same manner as in Example 2. Subsequently, baking was performed on the antistatic film No. 7 at 120° C. for 5 minutes to make the antistatic film experience a thermal history corresponding to an actual manufacturing process.

### (2) Etchability Test

The film thickness of the antistatic film before etching was measured using “α-STEP” manufactured by KLA-Tencor Corporation. Then, the antistatic film obtained in the above-mentioned (1) was masked using a photoresist, and subsequently etched at 25° C. for several minutes using an oxalic acid “ITO-07N” manufactured by Kanto chemical Co., Ltd. Thereafter, the film thickness of the antistatic film obtained after the etching was measured, and the etching rate was calculated by formula below.

Etching rate [nm/min]=(film thickness of antistatic film before etching−film thickness of antistatic film after etching)/(immersion time in etching solution)

As a result, it was confirmed that the antistatic film No. 7 had an etching rate of 10.5 nm/min and exhibited a satisfactory etching property with no residue.

### Example 4

### (1) Formation of Antistatic Film

An antistatic film No. 10 shown in Table 2 was formed in the same manner as in Example 2. Subsequently, baking was performed on the antistatic film No. 10 at 120° C. for 5 minutes to make the antistatic film experience a thermal history corresponding to an actual manufacturing process.

### (2) Durability Test

The sheet resistance of the antistatic film No. 10 obtained in the above-mentioned (1) was measured in the same manner as in Example 1. Then, a durability test was performed on the antistatic film under a humidity of 85% and a temperature of 80° C. for 96 hours using a high-temperature and high-humidity tester, and then the sheet resistance of the antistatic film after the durability test was measured.

As a result, the sheet resistance of the antistatic film before the durability test was 1.6×10¹¹Ω/□, whereas the sheet resistance thereof after the durability test was 1.4×10¹¹Ω/□, which showed that the antistatic film with excellent sheet resistance and durability was obtained.

### (3) Measurement of Transmittance

The spectral transmittance of the antistatic film formed on a glass substrate was measured over the spectral range of 850 to 250 nm using the visible-ultraviolet spectrophotometer “V-570” manufactured by JASCO Corporation.

As a result, the light transmittance of the antistatic film at a wavelength of 450 nm before the durability test was 96.2%, whereas the light transmittance of the antistatic film at a wavelength of 450 nm after the durability test was 96.0%, and the antistatic film with excellent sheet resistance and durability were obtained.

### Example 5

### (1) Formation of Antistatic Film

Antistatic films Nos. 11 to 15 were formed in the same manner as in Example 1, except that the film thicknesses were set at 20 nm and that the partial pressure of oxygen in the carrier gas was varied in a range from 0 to 8%, as shown in Table 3.

Furthermore, antistatic films Nos. 16 to 19 were formed in the same manner as mentioned above, except for using another sputtering target with a composition of In:Zn:Sn:V=19.6 atomic %:55.5 atomic %:22.9 atomic %:2.0 atomic % by adding V to In, Zn and Sn.

Moreover, as shown in Table 3, antistatic films Nos. 20 to 31 were formed in the same manner as mentioned above, except for substituting Mn, Co or Mo for V.

Then, baking was performed on the antistatic films Nos. 11 to 31 at 120° C. for 5 minutes to make the antistatic films experience a thermal history corresponding to an actual manufacturing process.

### (2) Composition Analysis

The composition of each metal element in the total content 100 atomic % of the metal elements was determined by an ICP luminescence analysis method.

The composition of each of the antistatic films Nos. 11 to 15 was In:Zn:Sn=21.2 atomic %:54.7 atomic %:24.1 atomic %.

The composition of each of the antistatic films Nos. 16 to 19 was In:Zn:Sn:V=22.0 atomic %:51.8 atomic %:24.7 atomic %:1.5 atomic %.

The composition of each of the antistatic films Nos. 20 to 23 was In:Zn:Sn:Mn=22.7 atomic %:49.2 atomic %:25.1 atomic %:3.0 atomic %.

The composition of each of the antistatic films Nos. 24 to 27 was In:Zn:Sn:Co=20.7 atomic %:45.9 atomic %:23.1 atomic %:10.3 atomic %.

The composition of each of the antistatic films Nos. 28 to 31 was In:Zn:Sn:Mo=21.7 atomic %:49.7 atomic %:23.9 atomic %:4.7 atomic %.

### (3) Test of Sheet Resistance and Transmittance

The sheet resistance of each of the antistatic films Nos. 11 to 31 obtained in the above-mentioned (1) was measured in the same manner as in Example 1.

The light transmittance at 450 nm of each of the antistatic films Nos. 11 to 31 obtained in the above-mentioned (1) was measured in the same manner as in Example 4.

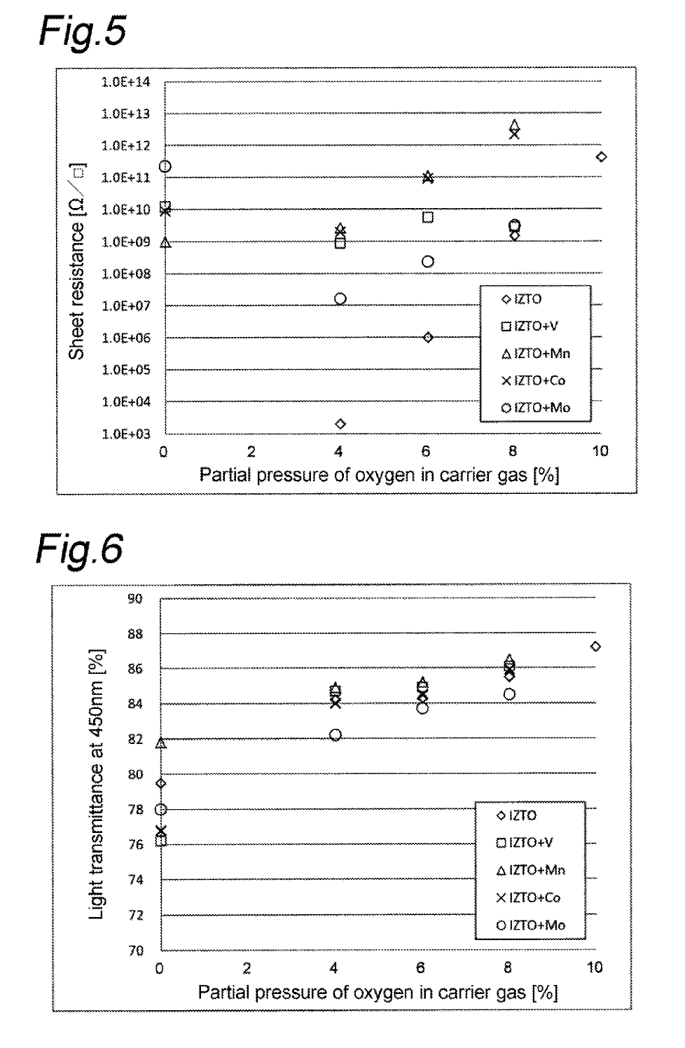

Table 3 shows the measurement results of the sheet resistances and the light transmittances at 450 nm. FIGS. 5 and 6 are graphs showing the relationship between the sheet resistances and the partial pressures of oxygen and the relationship between the transmittances and the partial pressures of oxygen, respectively.

In Table 3 and FIGS. 5 and 6, the respective antistatic films Nos. 11 to 15, Nos. 16 to 19, Nos. 20 to 23, Nos. 24 to 27, and Nos. 28 to 31 indicate “IZTO”, “IZTO+V”, “IZTO+Mn”, “IZTO+Co”, and “IZTO+Mo”, respectively.

TABLE 3

| | | Partial | Sheet | |
|---|---|---|---|---|
| | Exam- | pressure of | resistance | Transmittance |
| | ple 5 | oxygen in | (Ω/□) | (%) |
| | No. | carrier gas (%) | (After baking) | (After baking) |
| IZTO | 11 | 0 | — | 79.5 |
| | 12 | 4 | 2.0 × 10³ | 84.2 |
| | 13 | 6 | 1.0 × 10⁶ | 84.3 |
| | 14 | 8 | 1.5 × 10⁹ | 85.5 |
| | 15 | 10 | 4.1 × 10¹¹ | 87.2 |
| IZTO + V | 16 | 0 | 1.2 × 10¹⁰ | 76.2 |
| | 17 | 4 | 8.8 × 10⁸ | 84.7 |
| | 18 | 6 | 5.7 × 10⁹ | 84.9 |
| | 19 | 8 | 2.8 × 10⁹ | 86.1 |
| IZTO + Mn | 20 | 0 | 1.0 × 10⁹ | 81.8 |
| | 21 | 4 | 2.7 × 10⁹ | 84.9 |
| | 22 | 6 | 1.1 × 10¹¹ | 85.2 |
| | 23 | 8 | 4.3 × 10¹² | 86.5 |
| IZTO + Co | 24 | 0 | 9.0 × 10⁹ | 76.8 |
| | 25 | 4 | 2.0 × 10⁹ | 84.0 |
| | 26 | 6 | 9.1 × 10¹⁰ | 84.5 |
| | 27 | 8 | 2.2 × 10¹² | 85.9 |
| IZTO + Mo | 28 | 0 | 2.2 × 10¹¹ | 78.0 |
| | 29 | 4 | 1.6 × 10⁷ | 82.2 |
| | 30 | 6 | 2.3 × 10⁸ | 83.7 |
| | 31 | 8 | 3.1 × 10⁹ | 84.5 |

As can be seen from Table 3 and FIGS. 5 and 6, the antistatic films with V, Mn, Co or Mo added could achieve the higher sheet resistance even at a low partial pressure of oxygen, compared to the antistatic films with no element added. Due to the low partial pressures of oxygen, the sheet resistances of the antistatic films were less likely to vary, and thus it was easy to adjust the partial pressure of oxygen.

Furthermore, the antistatic films with V, Mn or Co added could achieve the high transmittance, compared to the antistatic films with Mo added, and thus was easy to achieve both the high sheet resistance and the high transmittance.

The disclosure of the present specification includes the following aspects.

### Aspect 1:

An antistatic film having a light-transmissive property provided on a light-transmissive member, containing In, Zn, Sn and O.

### Aspect 2:

The antistatic film according to aspect 1, further containing at least one selected from the group consisting of V, Mn, Co and Mo.

### Aspect 3:

The antistatic film according to aspect 2, containing at least one selected from the group consisting of V, Mn and Co.

### Aspect 4:

The antistatic film according to any one of aspects 1 to 3, wherein the antistatic film is provided on one surface of a transparent substrate which is the light-transmissive member, and a color filter is provided on another surface of the transparent substrate.

### Aspect 5:

The antistatic film according to any one of aspects 1 to 4, wherein a sheet resistance is 1×10⁷ to 1×10¹³Ω/□, and

a light transmittance at a wavelength of 450 nm is 95% or more at a film thickness of 10 nm.

### Aspect 6

A display input device including the antistatic film according to any one of aspects 1 to 5.

The present application claims priority to Japanese Patent Application No. 2016-064482 filed on Mar. 28, 2016. Japanese Patent Application No. 2016-064482 is incorporated herein by reference.

### DESCRIPTION OF REFERENCE NUMERALS

1 Antistatic film
2 First transparent substrate
3 Second transparent substrate
4 Touch sensor
5 Color filter
6 Liquid crystal layer
7 Polarizing plate
8 Backlight
100, 100A Display input device

1: An antistatic film provided on a light-transmissive member, the antistatic film comprising In, Zn, Sn and O,
wherein the antistatic film has a light-transmissive property.

2: The antistatic film according to claim 1, further comprising at least one selected from the group consisting of V, Mn, Co and Mo.

3: The antistatic film according to claim 1, wherein the light-transmissive member is a transparent substrate, and
the antistatic film is provide on one surface of the transparent substrate and a color filter is provided on another surface of the transparent substrate.

4: The antistatic film according to claim 2, wherein the light-transmissive member is a transparent substrate, and
the antistatic film is provide on one surface of the transparent substrate and a color filter is provided on another surface of the transparent substrate.

5: The antistatic film according to claim 1, wherein the antistatic film has a sheet resistance of 1×10⁷ to 1×10¹³Ω/□, and
a light transmittance at a wavelength of 450 nm of 82% or more at a film thickness of 10 nm.

6: The antistatic film according to claim 2, wherein the antistatic film has a sheet resistance of 1×10⁷ to 1×10¹³Ω/□, and
a light transmittance at a wavelength of 450 nm of 82% or more at a film thickness of 10 nm.

7: The antistatic film according to claim 3, wherein the antistatic film has a sheet resistance of 1×10⁷ to 1×10¹³Ω/□, and
a light transmittance at a wavelength of 450 nm of 82% or more at a film thickness of 10 nm.

8: The antistatic film according to claim 4, wherein the antistatic film has a sheet resistance of 1×10⁷ to 1×10¹³Ω/□, and
a light transmittance at a wavelength of 450 nm of 82% or more at a film thickness of 10 nm.

9: A display input device comprising the antistatic film according to claim 1.

10: A display input device comprising the antistatic film according to claim 2.

11: A display input device comprising the antistatic film according to claim 3.

12: A display input device comprising the antistatic film according to claim 4.

13: A display input device comprising the antistatic film according to claim 5.

14: A display input device comprising the antistatic film according to claim 6.

15: A display input device comprising the antistatic film according to claim 7.

16: A display input device comprising the antistatic film according to claim 8.
